(19) United States
(12) Patent Application Publication
(10) Pub. No.: US 2010/0099384 A1
(43) Pub. Date: Apr. 22, 2010

(54) E-MAIL TRANSMISSION METHOD AND MOBILE TERMINAL

(75) Inventors: Toshikazu Houmura, Kawasaki (JP); Tadaaki Enomoto, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/648,072

(22) Filed: Dec. 28, 2009

Related U.S. Application Data
(63) Continuation of application No. PCT/JP2007/062986, filed on Jun. 28, 2007.

(51) Int. Cl. H04L 12/58

(52) U.S. Cl. 455/412.1; 455/466

(57) ABSTRACT

According to an aspect of the embodiment, a cellular phone displays an e-mail creation screen, and when a one-touch key included in the cellular phone is pressed, an e-mail destination corresponding to the one-touch key is acquired from a one-touch key DB, and set to the e-mail. When a numeric key is pressed, the cellular phone acquires an e-mail text corresponding to the numeric key from an example sentence DB, and sets the text to the e-mail to transmit the e-mail to the e-mail destination.

### CROSS-REFERENCE TO RELATED APPLICATIONS

This is a continuation application of PCT application serial number PCT/JP2007/062986, filed on Jun. 28, 2007.

### FIELD

The embodiments discussed herein are related to an e-mail transmission method and a mobile terminal.

### BACKGROUND

In a conventional cellular phone, when a user of the cellular phone inputs an e-mail address of an e-mail destination, the user directly inputs the e-mail address. Alternatively, the user gets the cellular phone displaying an address book storing the e-mail addresses on a screen, and selects the e-mail address of the destination.

In a conventional cellular phone, there was a cellular phone provided with one-touch keys. However, in such cellular phone, the following operation is needed for the user to transmit the e-mail. Specifically, the user presses a one-touch key, and then a name, a phone number, and an e-mail address of a person (destination), who is registered in advance and is related with the one-touch key, are displayed on the screen. Next, the user performs an operation of selecting whether to transmit an e-mail to the destination of the name or to make a phone call. When the user selects to transmit the e-mail, a menu screen for creating the e-mail is displayed. Then, the user operates keys while referring to the menu screen to create an e-mail text, and transmit the e-mail.

Patent Document 1 described below describes a cellular phone as follow. The caller number of a missed call is compared with the phone numbers assigned to one-touch keys are compared. The sender the e-mail address of unread the e-mail is compared with the e-mail addresses assigned to the one-touch keys. When the user operates the one-touch keys, one of a call program and an e-mail program is started based on the comparison result.

Patent Document 1; Japanese Laid-Open Patent Publication No. 2006-319525

In a case that the destinations of the e-mail are not set in relation with specific keys of the cellular phone, it is needed for creating the e-mail to input directly an e-mail address or to select the e-mail address after temporarily displaying the address book, as above described. However, recently, registered addresses of the address book are increasing, so that it is difficult for the user to find out the e-mail destination from an enormous amount of (for example, several hundred) the e-mail addresses registered in the address book.

Furthermore, in the transmission of the e-mail using the cellular phone having the one-touch keys described above, it is needed for the user of the cellular phone, who intends to transmit the e-mail, to perform unnecessary operations. More specifically, even when the user intends to transmit the e-mail, the user firstly needs to perform an operation of pressing a one-touch key to display the name, the phone number, and the e-mail address of the destination, which is associated with the one-touch key. In addition, the user also needs to perform an operation of selecting whether to transmit the e-mail to the destination of the name or to make a phone call. The operation of displaying the name, the phone number, and the e-mail address on the screen and the operation of selecting whether to transmit the e-mail or to make a phone call are unnecessary operations for the user. After a menu screen for creating the e-mail is displayed due to selecting to transmit the e-mail, the user operates keys while referring to the menu screen to create an e-mail text, and finally presses a button (transmission button) for transmitting the e-mail.

### SUMMARY

According to an aspect of the embodiment, an e-mail transmission method in a mobile terminal includes displaying an e-mail creation screen; detecting a press of a one-touch key provided with the mobile terminal; referring to correspondence information between the one-touch key and an e-mail destination information stored in advance in storage means to acquire a destination of the e-mail corresponding to the one-touch key whose press is detected and a name corresponding to the destination; setting the name corresponding to the destination of the e-mail on the e-mail creation screen; creating a text of the e-mail; and transmitting the e-mail to the acquired destination of the e-mail.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an appearance of a mobile terminal of the present embodiment;

FIG. 2 is an example of a functional block diagram of a cellular phone;

FIG. 3 is a diagram illustrating an example of an e-mail/telephone selection screen;

FIG. 4 is a diagram illustrating an example of an e-mail creation screen;

FIG. 5 is a diagram illustrating an example of a selection screen of the type of the e-mail;

FIG. 6 is a diagram illustrating a data structure example of a one-touch key DB;

FIG. 7 is a diagram illustrating a data structure example of an example sentence DB;

FIG. 8 is a diagram illustrating a data structure example of the example sentence DB;

FIG. 9 is a diagram illustrating an example of an e-mail creation processing flow executed by an e-mail processing unit;

FIGS. 10A and 10B are diagrams illustrating examples of the e-mail creation screens; and

FIGS. 11A and 11B are diagrams illustrating display examples of an e-mail creation screen and a display screen during the e-mail transmission.

### DESCRIPTION OF EMBODIMENTS

The present embodiment provides an e-mail transmission method for easily setting a destination of the e-mail by an operation of a one-touch key during the creation of the e-mail to transmit the e-mail.

Further, the present embodiment provides a mobile terminal that easily sets a destination of the e-mail by an operation of a one-touch key during the creation of the e-mail to transmit the e-mail.

In the e-mail transmission method of the present embodiment, the creation of the text of the e-mail may further include detecting a press of a numeric key provided with the mobile terminal, referring to correspondence information between the numeric key and an e-mail text stored in advance in the storage means to acquire the e-mail text corresponding to the numeric key whose press is detected, and setting the acquired e-mail text on the e-mail creation screen.

In the e-mail transmission method of the present embodiment, a name corresponding to the e-mail destination set on the e-mail creation screen may be set in the acquired e-mail text, and the e-mail text set with the name is set on the e-mail creation screen.

According to another aspect of the embodiment, a mobile terminal may include means for displaying an e-mail creation screen; means for detecting a press of a one-touch key included in the mobile terminal; means for referring to correspondence information between the one-touch key and an e-mail destination information stored in advance in storage means to acquire a destination of the e-mail corresponding to the one-touch key whose press is detected and a name corresponding to the destination; means for setting the name corresponding to the destination of the e-mail on the e-mail creation screen;

means for creating a text of the e-mail; and means for transmitting the e-mail to the acquired destination of the e-mail.

The mobile terminal of the present embodiment may further includes means for detecting a press of a numeric key provided with the mobile terminal, and the means for creating the text of the e-mail may refer to correspondence information between the numeric key and an e-mail text stored in advance in storage means to acquire the e-mail text corresponding to the numeric key whose press is detected, and may set the acquired e-mail text on the e-mail creation screen.

In the mobile terminal of the present embodiment, the means for creating the text of the e-mail may set a name corresponding to the e-mail destination set on the e-mail creation screen in the acquired e-mail text, and may set the e-mail text set with the name on the e-mail creation screen.

An e-mail transmission method and a mobile terminal of the present embodiment displays an e-mail creation screen, and according to the press of a one-touch key, acquires the e-mail destination corresponding to the one-touch key and the name corresponding to the destination from storage means. The e-mail transmission method and the mobile terminal of the present embodiment set the name corresponding to the acquired destination of the e-mail on the e-mail creation screen, create a text of the e-mail, and transmit the e-mail to the acquired destination of the e-mail. The e-mail transmission method and the mobile terminal of the present embodiment acquire an e-mail text corresponding to a pressed numeric key from storage means and set the e-mail text on the e-mail creation screen to create the e-mail text. Therefore, according to the present embodiment, the user of the cellular phone can easily set the e-mail destination by an operation of the one-touch keys and easily create an e-mail text by an operation of the numeric keys to transmit the e-mail. For example, the user can transmit the e-mail to the e-mail destination just by performing an operation of pressing the one-touch key, an operation of pressing the numeric key, and an operation of pressing a button (transmission button) for transmitting the e-mail. As a result, the number of operations by the user can be reduced when creating the e-mail.

Furthermore, the e-mail transmission method and the mobile terminal of the present embodiment set, in the acquired e-mail text, the name corresponding to the e-mail destination set on the e-mail creation screen according to the press of the one-touch key to create the e-mail text. For example, the present embodiment can automatically create the e-mail by storing in advance texts of the e-mail corresponding to numeric keys, the texts including areas (name setting areas), in which the name corresponding to the e-mail destination should be set, in the storage means, acquiring a text corresponding to a numeric key from the storage means triggered by the press of the numeric key, and setting the name of the destination set on the e-mail creation screen to the name setting area in the text. As a result, the text to the e-mail destination can be automatically created according to the press of the one-touch key and the press of the numeric key, without storing texts to specific destinations which are associated with the numeric keys.

Preferred embodiments of the present invention will be explained with reference to accompanying drawings.

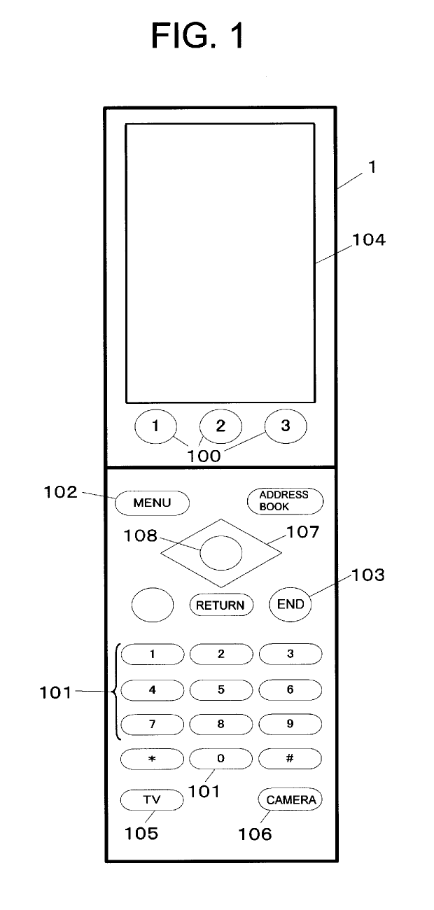

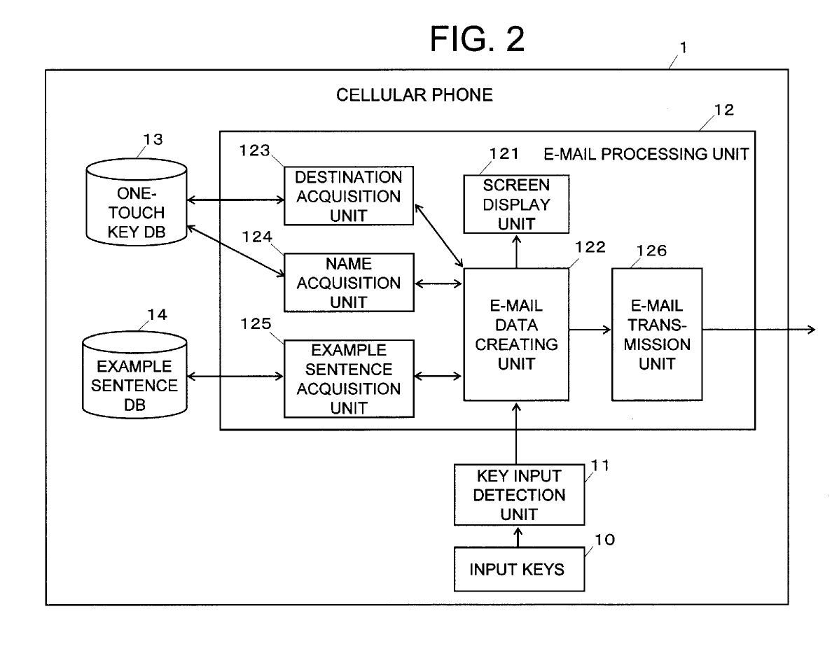

FIG. 1 is a diagram illustrating an example of an appearance of a mobile terminal of the present embodiment. In FIG. 1, a cellular phone 1 is described as an example of the mobile terminal of the present embodiment (the same applies to other FIGS. 2 to 11B). It is well known that the cellular phone 1 has a normal telephone function and an e-mail function.

The cellular phone 1 illustrated in FIG. 1 includes three one-touch keys 100 corresponding to one-touch key numbers “1”, “2”, and “3”, and ten numeric keys 101 corresponding to numbers “0” to “9”. In FIG. 1, numeric 102 denotes a MENU key as a key for displaying an operation menu of the cellular phone 1 on a display screen, numeric 103 denotes an END key as a key for ending the operation of the cellular phone 1, and numeric 104 denotes the display screen of the cellular phone 1. As illustrated in FIG. 1, the cellular phone 1 includes various input keys other than one-touch keys 100, the numeric keys 101, the MENU key 102, and the END key 103. For example, the cellular phone 1 includes a TV key 105 as an input key for displaying TV broadcasting on the display screen 104, a CAMERA key 106 as an input key for switching the cellular phone 1 to a camera shooting mode, a cursor key 107 as a key for moving a cursor to various setting targets displayed on the display screen 104, and a selection key 108 as a key for selecting a setting target at a location of the cursor key.

Numbers of the one-touch keys 100 and numbers of the numeric keys 101, which are provided in the cellular phone 1, are not limited to the above example, and the cellular phone 1 may include appropriate numbers of one-touch keys 100 and appropriate numbers of the numeric keys 101.

FIG. 2 is an example of a functional block diagram of the cellular phone illustrated in FIG. 1. The cellular phone 1 includes input keys 10, a key input detection unit 11, an e-mail processing unit 12, a one-touch key database (DB) 13, and an example sentence database (DB) 14.

The input keys 10 are input keys such as the one-touch keys 100, the numeric keys 101, the MENU key 102, the END key 103, the TV key 105, the CAMERA key 106, the cursor key 107, and the selection key 108, which are described above with reference to FIG. 1. For example, a user of the cellular phone 1 presses the input keys 10 to input operation information of the cellular phone 1. In other words, the input keys 10 are input means for inputting the operation information of the cellular phone 1.

The key input detection unit 11 detects the press of the input keys 10 (detects the input of operation information). In other words, the key input detection unit 11 is means for detecting the press of the one-touch keys 100 included in the mobile terminal (cellular phone 1). And, the key input detection unit 11 is means for detecting the press of the numeric keys 101 included in the mobile terminal (cellular phone 1).

The e-mail processing unit 12 specifies an e-mail destination, creates a text of an e-mail, and transmit the e-mail to the destination, according to the detection result on the press of the input keys 10 by the key input detection unit 11.

The one-touch key DB 13 stores, in advance, correspondence information between the one-touch keys 100 illustrated in FIG. 1 and e-mail destination information. The e-mail destination information indicates destinations of the e-mail, and includes e-mail addresses of the destinations of the e-mail, phone numbers of the destinations of the e-mail, and names of persons of the destinations of the e-mail, for example. The example sentence DB 14 stores, in advance, correspondence information between the numeric keys 101 illustrated in FIG. 1 and e-mail texts. According to the present embodiment, the example sentence DB 14 stores, in advance, correspondence information between numeric keys 101 and titles of the e-mail texts, and correspondence information between numeric keys 101 and the e-mail texts.

The e-mail processing unit 12 includes a screen display unit 121, an e-mail data creation unit 122, a destination acquisition unit 123, a name acquisition unit 124, an example sentence acquisition unit 125, and an e-mail transmission unit 126.

The screen display unit 121 receives an instruction of the e-mail data creation unit 122, and then displays various kind of information, which is needed to create the e-mail, on the display screen 104 of the cellular phone 1 illustrated in FIG. 1. Specifically, the screen display unit 121 displays an e-mail creation screen. The e-mail creation screen is a screen for creating the e-mail. In other words, the screen display unit 121 is means for displaying the e-mail creation screen.

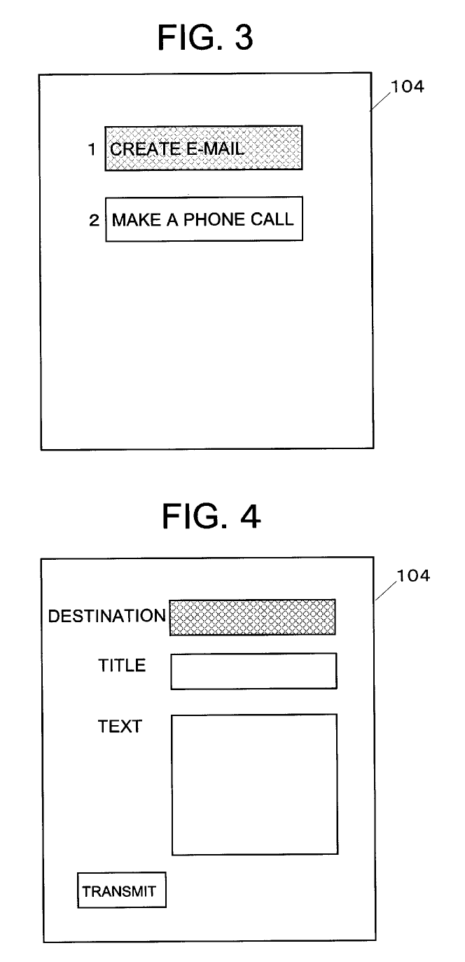

For example, the key input detection unit 11 detects the press of the MENU key 102 illustrated in FIG. 1, and the e-mail data creation unit 122 receives the detection result. Then, the screen display unit 121 receives an instruction of the e-mail data creation unit 122, and displays a screen (an e-mail/telephone selection screen) for selecting whether to create the e-mail or make a phone call as illustrated in FIG. 3, for example. A shaded part illustrated on the e-mail/telephone selection screen of FIG. 3 is a cursor. When the user operates (presses) the cursor key 107 and the selection key 108 illustrated in FIG. 1, for example, and selects to create the e-mail on the e-mail/telephone selection screen, the screen display unit 121 displays an e-mail creation screen as illustrated in FIG. 4, for example.

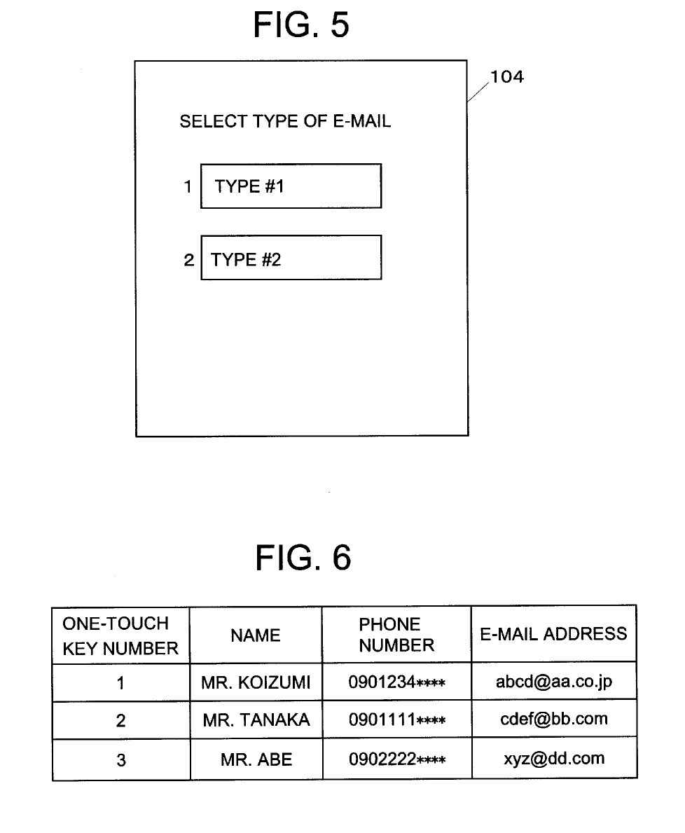

According to the present embodiment, when the creation of the e-mail is selected after the selection screen as illustrated in FIG. 3 is displayed on the display screen 104, the screen display unit 121 may display a selection screen of an e-mail type as illustrated in FIG. 5 according to the instruction of the e-mail data creation unit 122. Further, when the e-mail type is selected according to a designating input by the user, the screen display unit 121 may display the e-mail creation screen as illustrated in FIG. 4.

Among the types of the e-mail illustrated in FIG. 5, for example, a type #1 indicates the e-mail having an e-mail address as the destination, and a type #2 indicates the e-mail having a phone number as the destination. The e-mail having the phone number as the destination is, for example, an e-mail of a short message service.

The e-mail data creation unit 122 instructs the screen display unit 121 to display, on the screen, various kind of information which is needed to create the e-mail. For example, the e-mail data creation unit 122 instructs the screen display unit 121 to display the e-mail creation screen on the display screen 104.

When the key input detection unit 11 detects the press of a one-touch key 100 illustrated in FIG. 1, the e-mail data creation unit 122 instructs the destination acquisition unit 123 to acquire a destination of the e-mail corresponding to the one-touch key 100 whose press is detected, and the name corresponding to the destination from the one-touch key DB 13.

Specifically, the e-mail data creation unit 122 stores the one-touch key number of the one-touch key 100 (one of the numbers “1” to “3” in the example of the one-touch keys 100 illustrated in FIG. 1), whose press is detected by the key input detection unit 11, in a predetermined buffer. The e-mail data creation unit 122 then transmits the one-touch key number stored in the predetermined buffer to the destination acquisition unit 123 to acquire the e-mail destination (for example, the e-mail address) corresponding to the one-touch key number and the name corresponding to the destination from the one-touch key DB 13. In other words, the e-mail data creation unit 122 and the destination acquisition unit 123 are means for referring to the corresponding information between the one-touch keys 100 and the e-mail destination information stored in advance in the storage means (one-touch key DB 13), and means for acquiring the e-mail destination corresponding to the one-touch key 100 whose press is detected and the name corresponding to the destination.

The e-mail data creation unit 122 sets the acquired destination of the e-mail as the e-mail destination, and sets the name corresponding to the acquired destination of the e-mail, on the e-mail creation screen. The e-mail data creation unit 122 also creates an e-mail text.

According to the present embodiment, the e-mail data creation unit 122 determines whether to acquire the e-mail address or to acquire the phone number as the e-mail destination, according to the type of the e-mail selected from the selection screen of type of the e-mail as illustrated in FIG. 5. The e-mail data creation unit 122 then instructs the destination acquisition unit 123 to acquire the determined e-mail address or the determined phone number as the e-mail destination.

According to the present embodiment, when the key input detection unit 11 detects the press of a numeric key 101, the e-mail data creation unit 122 instructs the example sentence acquisition unit 125 to acquire an e-mail text corresponding to the numeric key whose press is detected from the example sentence DB 14. The e-mail data creation unit 122 sets the acquired e-mail text on the e-mail creation screen to create the text of the e-mail. In other words, the e-mail data creation unit 122 and the example sentence acquisition unit 125 are means for referring to the correspondence information between the numeric keys 101 and the e-mail texts, which are stored in advance in the storage means (example sentence DB 14), to acquire the e-mail text corresponding to the numeric key whose press is detected, and means for setting the acquired e-mail text on the e-mail creation screen.

The e-mail data creation unit 122 may instruct the example sentence acquisition unit 125 to acquire the e-mail text corresponding to the numeric key and a title of the text corresponding to the numeric key from the example sentence DB 14, and may set the acquired e-mail text and the title of the text on the e-mail creation screen to create the e-mail.

According to the present embodiment, the e-mail data creation unit 122 instructs the name acquisition unit 124 to acquire a name corresponding to the e-mail destination, which is set on the e-mail creation screen. Specifically, the e-mail data creation unit 122 transmits the number of one-touch key 100 stored in the predetermined buffer to the name acquisition unit 124 to cause the name acquisition unit 124 to acquire the name corresponding to the one-touch key number from the one-touch key DB 13. Then, the e-mail data creation unit 122 sets (or stores) the acquired name in the acquired e-mail text, and sets the e-mail text set with the name on the e-mail creation screen.

The e-mail data creation unit 122 sets the e-mail destination and the text of the e-mail on the e-mail creation screen, so that the creation of the e-mail to be transmitted is completed. The creation of the e-mail to be transmitted may be completed when the e-mail data creation unit 122 sets the e-mail destination, the text of the e-mail, and the title of the text on the e-mail creation screen.

According to the present embodiment, the e-mail data creation unit 122 may set the name corresponding to the e-mail destination, which is acquired by the destination acquisition unit 123 and set by the e-mail data creation unit 122 on the e-mail creation screen, in the e-mail text, without instructing the name acquisition unit 124 to acquire the name of the e-mail.

In other words, the e-mail data creation unit 122 is means for setting the name corresponding to the e-mail destination, which is set on the e-mail creation screen in the e-mail text acquired by the example sentence acquisition unit 125, and means for setting the e-mail text set with the name on the e-mail creation screen.

The destination acquisition unit 123 receives the instruction of the e-mail data creation unit 122, and refers to the correspondence information between the one-touch keys 100 and the e-mail destination information stored in advance in the one-touch key DB 13. Then, the destination acquisition unit 123 acquires the e-mail destination corresponding to the one-touch key 100 whose press is detected, and transmits the acquired destination of the e-mail to the e-mail data creation unit 122.

The name acquisition unit 124 receives the instruction of the e-mail data creation unit 122, and acquires the name, which is set on the e-mail creation screen and corresponds to the e-mail destination (in other words, the name corresponding to the one-touch key 100 whose press is detected).

In the present embodiment, for example, when the e-mail creation screen as illustrated in FIG. 4 is displayed, an operation mode is set to the e-mail data creation unit 122. In the operation mode, the e-mail data creation unit 122, which is triggered by the press of a one-touch key 100, instructs the destination acquisition unit 123 to acquire the e-mail address corresponding to the pressed one-touch key 100 from the example sentence DB 14 and the e-mail data creation unit 122, which is triggered by the press of a numeric key 101, instructs the example sentence acquisition unit 125 to acquire the e-mail text corresponding to the pressed numeric key 101 from the example sentence DB 14.

The example sentence acquisition unit 125 receives the instruction of the e-mail data creation unit 122, and refers to the correspondence information between the numeric keys 101 and the e-mail texts stored in advance in the example sentence DB 14. Then, the example sentence acquisition unit 125 acquires the e-mail text corresponding to the numeric key 101, whose press is detected by the key input detection unit 11, and transmits the acquired e-mail text to the e-mail data creation unit 122. According to another embodiment, the example sentence acquisition unit 125 may receive the instruction of the e-mail data creation unit 122, and may refer to the correspondence information between the numeric keys 101 and the titles of the e-mail texts as well as the e-mail texts stored in advance in the example sentence DB 14. And then, the example sentence acquisition unit 125 may acquire the title of the e-mail text and the e-mail text corresponding to the numeric key, whose press is detected by the key input detection unit 11.

The e-mail transmission unit 126 transmits the e-mail completed with its creation (for example, an e-mail in which the destination, the title, and the text of the e-mail are set on the e-mail creation screen) to the e-mail destination.

FIG. 6 is a diagram illustrating a data structure example of a one-touch key DB. In the one-touch key DB 13, for example, a name, a phone number, and an e-mail address are set in advance for each one-touch key number which is associated with the one-touch key number. The one-touch key numbers are numbers of the one-touch keys 100 provided with the cellular phone 1. The names are names corresponding to destinations of the e-mail. The phone numbers are phone numbers of destinations of the e-mail. The e-mail addresses are the e-mail addresses of destinations of the e-mail.

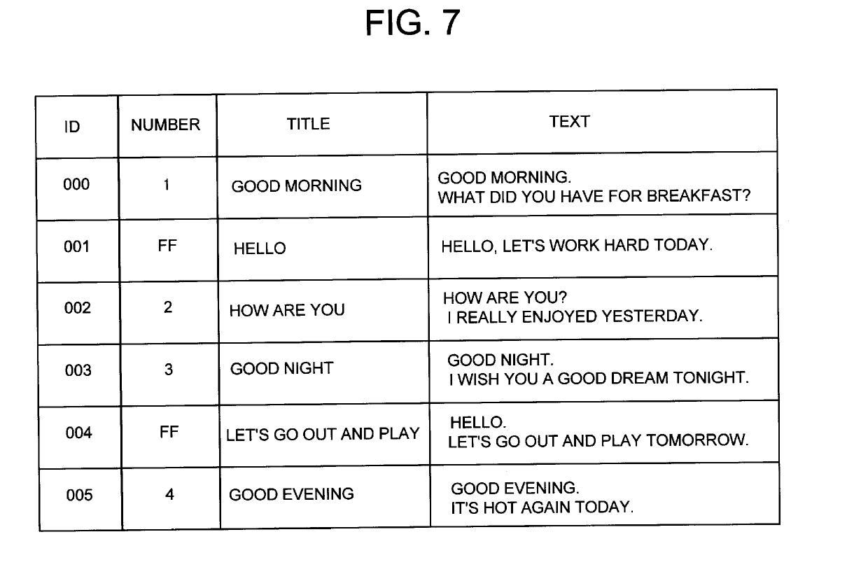

FIG. 7 is a diagram illustrating a data structure example of an example sentence DB. In the example sentence DB, for example, a title, a text, and an ID are set in advance for each number which is associated with the number. The numbers are numbers indicated by the numeric keys 101. The titles are titles of an e-mail. The texts are texts of an e-mail. The IDs are identifiers for uniquely identifying the records (each including one line of data) of the example sentence DB 14. In the example illustrated in FIG. 7, the records set with “FF” in the field of number indicate records not set with numbers of the numeric keys 101.

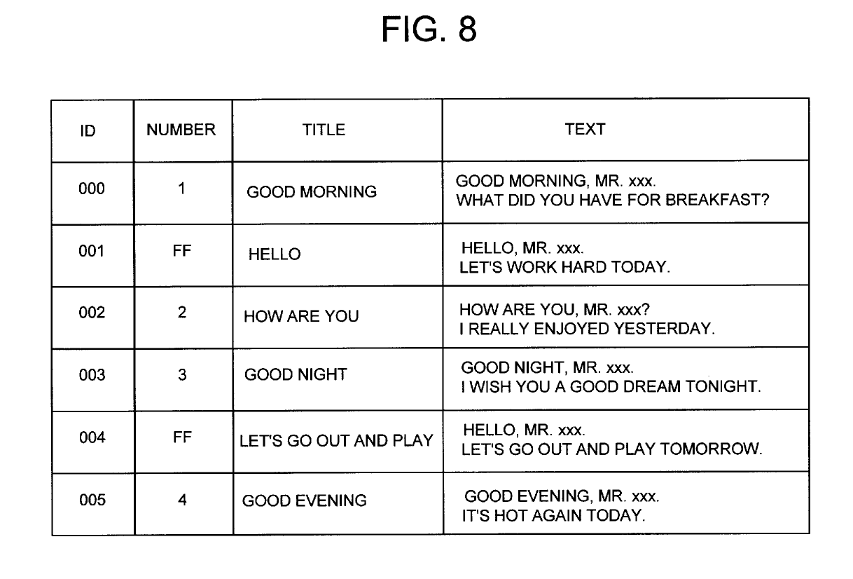

According to the present embodiment, data as illustrated in FIG. 8 is set in advance in the example sentence DB 14. More specifically, in the field of a text of the example sentence DB 14 illustrated in FIG. 8, texts including areas (name setting areas) illustrated such as “xxx, . . . ” are set, in which names corresponding to the destinations is to be set. According to the present embodiment, the e-mail data creation unit 122 may set the name corresponding to the e-mail destination acquired by the name acquisition unit 124 to the name setting area of the text acquired by the example sentence acquisition unit 125 from the example sentence DB 14 illustrated in FIG. 8, to create the e-mail text.

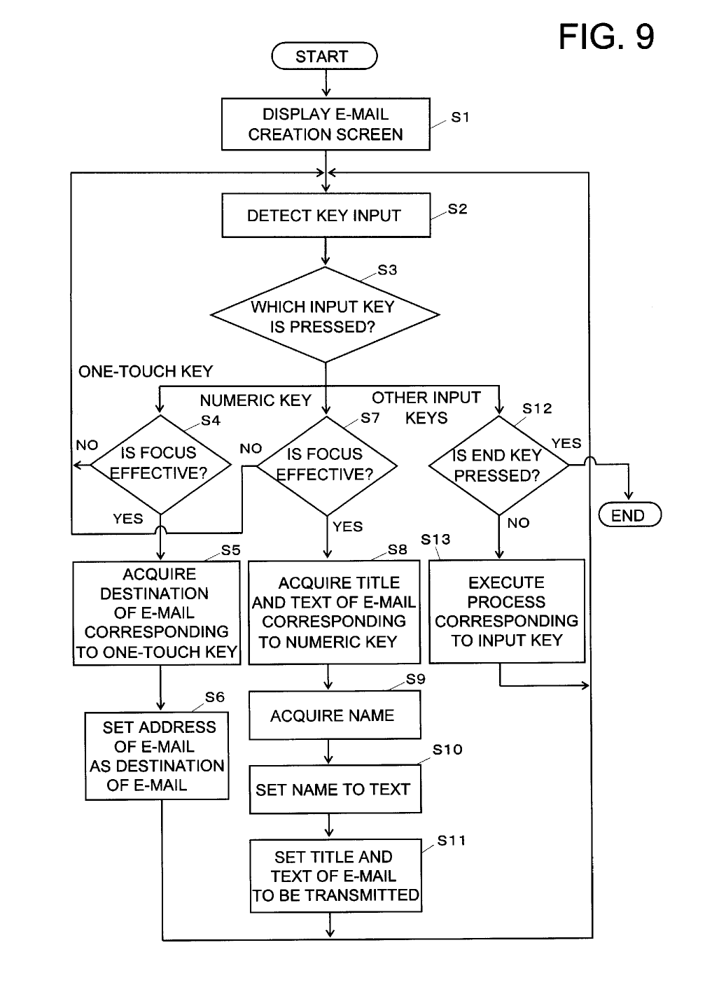

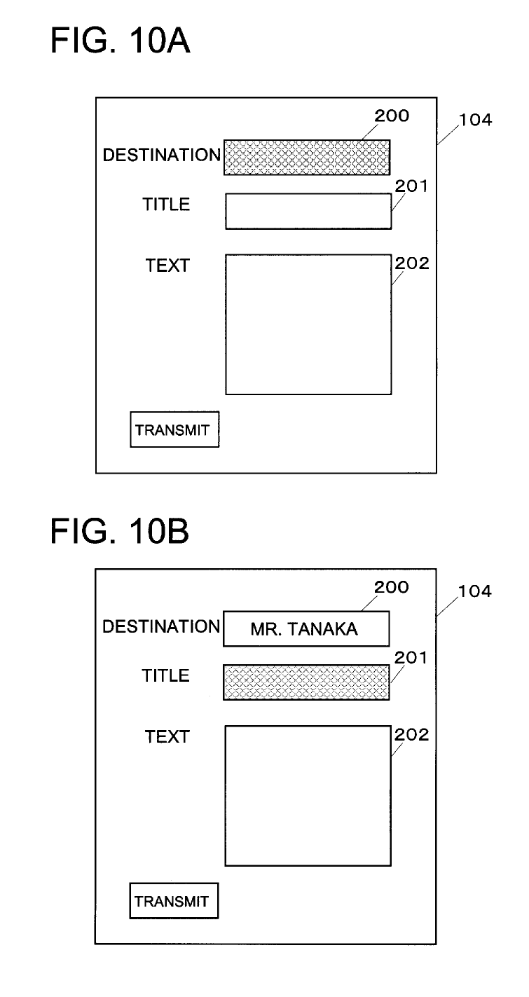

FIG. 9 is a diagram illustrating an example of an e-mail creation processing flow executed by an e-mail processing unit. The screen display unit 121 first displays an e-mail creation screen (step S1). In step S1, for example, an e-mail creation screen as illustrated in FIG. 10A is displayed. The e-mail creation screen illustrated in FIG. 10A includes a destination setting area 200, which is an area for setting the e-mail destination (the name corresponding to the e-mail destination in the example illustrated in FIG. 10A), a title setting area 201, which is an area for setting the title of the e-mail text, and a text setting area 202, which is an area for setting the e-mail text. The e-mail destination, the title of the e-mail text, and the e-mail text are setting targets in the creation processing of the e-mail. In the present embodiment, for example, the setting targets are set in order of the e-mail destination, the title of the e-mail text, and the e-mail text. According to the present embodiment, only the e-mail destination and the e-mail text may be set as the setting targets.

The shaded part in the e-mail creation screen in FIG. 10A indicates a cursor illustrating the setting target. For example, in the e-mail transmission method of the present embodiment, it is triggered by the press of the one-touch key 100 to set the name corresponding to the e-mail destination to the destination setting area 200, and, after that, it is triggered by the press of the numeric key 101 to set the title of the e-mail text to the title setting area 201 and to set the e-mail text to the text setting area 202. Therefore, in step S1, the screen display unit 121 adjusts and displays the cursor at a location of the destination setting area 200 to display that the first setting target is the e-mail destination, as illustrated in FIG. 10A.

When an input key 10 is pressed according to an operation of a user, the key input detection unit 11 detects the press (key input) of the input key 10 (step S2). The e-mail data creation unit 122 determines which input key 10 is pressed (step S3).

The e-mail data creation unit 122 first determines that a one-touch key 100 is pressed, and then determines whether the cursor is at the location of the destination setting area 200 (in other words, whether a focus is effective) on the e-mail creation screen (step S4). When the e-mail data creation unit 122 determines that the cursor is not at the location of the destination setting area 200, the processing returns to step S2. When the e-mail data creation unit 122 determines that the cursor is at the location of the destination setting area 200, the e-mail data creation unit 122 instructs the destination acquisition unit 123 to acquire the e-mail destination corresponding to the pressed one-touch key 100 (step S5). For example, when the one-touch key 100 with one-touch key number “2” is pressed, the destination acquisition unit 123 refers to the one-touch key DB 13 illustrated in FIG. 6, and acquires an e-mail address “cdef@bb.com” and a name “MR. TANAKA”, which are correspond to the one-touch key number “2”.

The e-mail data creation unit 122 sets the e-mail destination acquired by the destination acquisition unit 123 as the e-mail destination (step S6), and returns to step S2. The e-mail data creation unit 122, for example, sets the e-mail address “cdef@bb.com” as the e-mail address of the e-mail destination, and sets the name “MR. TANAKA” to the destination setting area 200 in the e-mail creation screen. As a result, for example, the name “MR. TANAKA” is set to the destination setting area 200 on the e-mail creation screen, as illustrated in FIG. 10B. And, as illustrated in FIG. 10B, the e-mail data creation unit 122 moves the cursor to a location of the title setting area 201, which is an area set with a second setting target (the title of the e-mail text).

In step S3, after the e-mail data creation unit 122 first determines that the numeric key 101 is pressed, the e-mail data creation unit 122 further determines whether the cursor is at a location (whether a focus is effective) of the title setting area 201 on the e-mail creation screen (step S7).

When the e-mail data creation unit 122 determines that the cursor is not at the location of the title setting area 201, the processing returns to step S2. When the e-mail data creation unit 122 determines that the cursor is at the location of the title setting area 201, the e-mail data creation unit 122 instructs the destination acquisition unit 123 to acquire the title and the text of the e-mail, which correspond to the pressed numeric key 101 (step S8). For example, when the numeric key 101 with number “1” is pressed, the destination acquisition unit 123 refers to the one-touch key DB 13 illustrated in FIG. 8 to acquire the title “GOOD MORNING” and the text “GOOD MORNING, xxx. WHAT DID YOU HAVE FOR BREAKFAST?”, which correspond to the number “1”.

Next, the e-mail data creation unit 122 instructs the name acquisition unit 124 to acquire the name set on the e-mail creation screen (step S9). In step S9, for example, the name acquisition unit 124 refers to the one-touch key DB 13 illustrated in FIG. 6 to acquire the name (for example, “MR. TANAKA”), which corresponds to the one-touch key number (for example, “2”) of the one-touch key 100 determined to be pressed in step S3.

The e-mail data creation unit 122 then sets the name acquired in step S9 to the text acquired in step S8 (step S10). For example, the e-mail data creation unit 122 sets the name “MR. TANAKA” to the area (name setting area) corresponding to “xxx” of the text “GOOD MORNING, xxx. WHAT DID YOU HAVE FOR BREAKFAST?”, which is acquired in step S8, thereby creates a text “GOOD MORNING, MR. TANAKA. WHAT DID YOU HAVE FOR BREAKFAST?”.

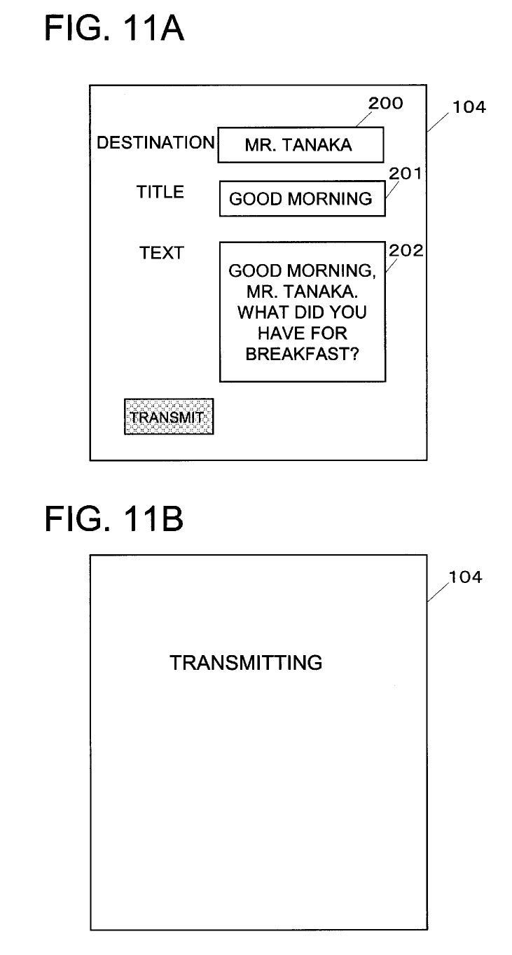

The e-mail data creation unit 122 then sets the title acquired in step S8 and the text set with the name in step S10 as the title and the text of the e-mail to be transmitted, respectively (step S11). In step S11, for example, the e-mail data creation unit 122 sets “GOOD MORNING” to the title setting area 201 in the e-mail creation screen, and sets “GOOD MORNING, MR. TANAKA. WHAT DID YOU HAVE FOR BREAKFAST?” to the text setting area 202, as illustrated in FIG. 11A, thereby sets the title and the text of the e-mail to be transmitted. Further, in step S11, the e-mail data creation unit 122 moves the cursor to the button (transmission button) displayed with “TRANSMIT” as illustrated in the shaded part of FIG. 11A.

FIG. 11A illustrates a state in which the e-mail destination is set to the destination setting area 200 in the e-mail creation screen, the title of the e-mail text is set to the title setting area 201, and the e-mail text is set to the text setting area 202. In this state, the user of the cellular phone 1 presses the transmission button. As a result, the e-mail transmission unit 126 transmits the e-mail to the e-mail destination according to the designation input by the press of the transmission button. The screen display unit 121 displays information, which indicates that the e-mail is being transmitted, on the display screen 104 as illustrated in FIG. 11B, for example.

Returning to FIG. 9, in step S3, when the e-mail data creation unit 122 first determines that an input key 10 other than one-touch keys 100 and the numeric keys 101 is pressed, the e-mail data creation unit 122 further determines whether the END key 103 illustrated in FIG. 1 is pressed (step S12). When the e-mail data creation unit 122 determines that the END key 103 is pressed, the processing finishes. When the e-mail data creation unit 122 determines that the END key 103 is not pressed, the e-mail data creation unit 122 executes a processing which corresponds to the pressed input key 10 (step S13), and returns to step S2. In step S13, for example, when the pressed input key 10 is the TV key 105 illustrated in FIG. 1, the e-mail data creation unit 122 instructs the screen display unit 121 to display TV broadcasting on the display screen 104.

In the present embodiment, in step S1 of FIG. 9, the screen display unit 121 may first display the selection screen of type of the e-mail as illustrated in FIG. 5, and may display, when the type of the e-mail is selected according to the designation input by the user, the e-mail creation screen as illustrated in FIG. 10A. In step S5 of FIG. 9, the e-mail data creation unit 122 may instruct the destination acquisition unit 123 to acquire a destination according to the selected type of the e-mail as the e-mail destination corresponding to the pressed one-touch key 100.

For example, when the e-mail having the e-mail address as the destination is selected as the type of the e-mail, the e-mail data creation unit 122 instructs the destination acquisition unit 123 to acquire the e-mail address as the e-mail destination corresponding to the pressed one-touch key 100. When the e-mail having the phone number as the destination is selected as the type of the e-mail, the e-mail data creation unit 122 instructs the destination acquisition unit 123 to acquire the phone number as the e-mail destination corresponding to the pressed one-touch key 100.

According to another embodiment, in step S8 of FIG. 9, the destination acquisition unit 123 may acquire an e-mail text which does not have a name setting area. For example, in step S8, the destination acquisition unit 123 acquires the title and the text of the e-mail, which correspond to the pressed numeric key 101 from the one-touch key DB 13 illustrated in FIG. 7. And then, in place of the processing of steps S9 to S11 of FIG. 9, the e-mail data creation unit 122 may execute a processing for setting the title and the text of the e-mail acquired in step S8 as the title and the text of the e-mail to be transmitted.

According to the e-mail transmission method and the mobile terminal of the present embodiment, the user of a cellular phone can easily set the e-mail destination by the operation of the one-touch key to transmit the e-mail. For example, the user can transmit the e-mail to the e-mail destination just by performing the operation of pressing the one-touch key, the operation of pressing the numeric key, and the operation of pressing the button (transmission button) for transmitting the e-mail. As a result, number of operations by the user for creating the e-mail can be significantly reduced.

Furthermore, according to the e-mail transmission method and the mobile terminal of the present embodiment, the e-mail can be automatically created by, for example, storing in advance texts of the e-mail corresponding to numeric keys, the texts including areas (name setting areas) set with names corresponding to the destinations of the e-mail, in storage means, by acquiring a text in the storage means triggered by the press of the numeric key, and by setting the name of the destination already set on the e-mail creation screen to the name setting area in the text. As a result, the text for the e-mail destination can be automatically created by the press of the one-touch key and the press of the numeric key, without storing texts to specific destinations which are associated with the numeric keys.

All examples and conditional language recited herein are intended for pedagogical purpose to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An e-mail transmission method in a mobile terminal, the e-mail transmission method comprising:
displaying an e-mail creation screen;
detecting a press of a one-touch key provided with the mobile terminal;
referring to correspondence information between the one-touch key and an e-mail destination information stored in advance in storage means to acquire a destination of the e-mail corresponding to the one-touch key whose press is detected and a name corresponding to the destination;
setting the name corresponding to the destination of the e-mail on the e-mail creation screen;
creating a text of the e-mail; and
transmitting the e-mail to the acquired destination of the e-mail.

2. The e-mail transmission method according to claim 1, wherein the creation of the text of the e-mail further comprises detecting a press of a numeric key provided with the mobile terminal, referring to correspondence information between the numeric key and an e-mail text stored in advance in the storage means to acquire the e-mail text corresponding to the numeric key whose press is detected, and setting the acquired e-mail text on the e-mail creation screen.

3. The e-mail transmission method according to claim 2, wherein the creation of the text of the e-mail further comprises setting a name corresponding to the e-mail destination set on the e-mail creation screen in the acquired e-mail text, and setting the e-mail text set with the name on the e-mail creation screen.

4. A mobile terminal comprising:
a displaying unit which displays an e-mail creation screen;
a first detecting unit which detects a press of a one-touch key included in the mobile terminal;
a referring unit which refers to correspondence information between the one-touch key and an e-mail destination information stored in a first storage unit to acquire a destination of the e-mail corresponding to the one-touch key whose press is detected and a name corresponding to the destination;
a setting unit which sets the name corresponding to the destination of the e-mail on the e-mail creation screen;
a creating unit which creates a text of the e-mail; and
a transmitting unit which transmits the e-mail to the acquired destination of the e-mail.

5. The mobile terminal according to claim 4, further comprising:
a second detecting unit which detects a press of a numeric key provided with the mobile terminal,
wherein the creating unit creates the text of the e-mail refers to correspondence information between the numeric key and an e-mail text stored in a second storage unit to acquire the e-mail text corresponding to the numeric key whose press is detected, and sets the acquired e-mail text on the e-mail creation screen.

6. The mobile terminal according to claim 5, wherein the creating unit creates the text of the e-mail sets a name corresponding to the e-mail destination set on the e-mail creation screen in the acquired e-mail text, and sets the e-mail text set with the name on the e-mail creation screen.
